(19) United States
(12) Patent Application Publication
(10) Pub. No.: US 2008/0293316 A1
(43) Pub. Date: Nov. 27, 2008

(54) Suede Like Artificial Leather with Excellent Strength and Elongation Properties

(76) Inventors: Yeong-Nam Hwang, Gyeongsangbuk-do (KR); Won-Jun Kim, Gyeongsangbuk-do (KR); Sung-Won Kang, Busan (KR)

Correspondence Address: BIRCH STEWART KOLASCH & BIRCH, PO BOX 747, FALLS CHURCH, VA, 22040-0747, US

(21) Appl. No.: 12/158,032

(22) PCT Filed: Dec. 18, 2006
(86) PCT No.: PCT/KR2006/005510

§ 371 Date: Jun. 18, 2008

(30) Foreign Application Priority Data
Dec. 19, 2005 (KR) 10-2005-0125067

(51) Int. Cl. B32B 5/02

(52) U.S. Cl. 442/60

(57) ABSTRACT

The present invention relates to a suede-like artificial leather with excellent strength and elongation properties. The suede-like artificial leather comprises a composite sheet having polyurethane filled therein, the composite sheet comprising: a non-woven fabric of ultrafine short fibers entangled with each other and having a thickness less than 0.3 denier; and a woven or knitted fabric placed in the non-woven fabric, entangled with the ultrafine short fibers of the non-woven fabric, and having an constant load elongation of 10 to 30% at a load of 8 kgf, wherein the tensile strength in longitudinal and lateral directions is 35 to 60 kgf/50 iτini and the constant load elongation in longitudinal and lateral directions is 8 to 25%. The suede-like artificial leather is useful as materials for vehicles and furniture requiring durability because of its excellent tensile strength and constant load elongation.

### TECHNICAL FIELD

The present invention relates to a suede-like artificial leather with excellent strength and elongation properties, and more particularly, to a suede-like artificial leather which is useful as high durability materials for vehicles, furniture, etc. because it has an excellent tensile strength and constant load elongation.

Nowadays, an artificial leather made of non-woven fabric with three-dimensionally crosslinked micro-fibers and polyurethane resin (polyurethane elastomer) impregnated in the non-woven fabric is widely used as material rapidly replacing natural leather used for furniture or vehicles because it has a soft touch and unique appearance similar to those of the natural leather.

Recently, artificial leather having a high functionality, as well as imitating the soft touch and unique appearance conventionally characteristic of a natural leather, is being actively developed. Particularly, there is a demand for an artificial leather which requires form stability so as to have durability against excessive friction and external force when used for vehicles, furniture, etc. and which has a suitable strength and elongation so as to make sewing and mounting workability easier as it is to be used for a flexed region.

As conventional techniques for giving an artificial leather form stability, U.S. Pat. No. 5,112,421, U.S. Laid-Open Patent No. 2005/0009426 A1 and so on propose a method in which a fabric is inserted between web layers made of cotton in the production of a non-woven fabric so as to have a stable stitching strength and constant load elongation properties.

However, the above-mentioned method is disadvantageous in that although the strength is high, the constant load elongation becomes much smaller due to the insertion of a fabric, which makes manual work, such as a seat mounting, difficult when this method is applied to furniture or vehicles with a lot of flexed regions.

Meanwhile, Japanese Patent Laid-Open No. 2004-332173 suggests a method of producing an artificial leather by inserting a stretch knitted or woven fabric made of polyurethane elastic yarns by a water jet method into the middle of a short fiber web layer during the production of a non-woven fabric.

However, according to the above-described method, knitted or woven fabrics are produced only from polyurethane elastic yarns, such that it is difficult to insert by needle punching. Therefore, bonded pleats are formed because bonding is done using a water-jet method, thereby making the surface irregular. In addition, the elongation is excessively high and the strength is weak, which leads to unsatisfactory form stability such that the fabric may not be used for furniture and vehicles.

As described above, the artificial leathers produced by the conventional methods have good strength and poor elongation or vise versa, and are not satisfactory in appearance. Thus, they are unsuitable as artificial leathers for furniture and vehicles that require high durability along with aesthetic appearance.

### DISCLOSURE OF INVENTION

### Problem to be Solved by the Invention

It is an object of the present invention to provide an artificial leather which has strength and elongation so as to improve the sewing and mounting workability of a flexed region, as well as forming stability against excessive friction and external force by controlling the strength and elongation of woven and knitted fabrics to be bonded to a web and adequately realize the strength and elongation of a final product depending on the strength and elongation of woven and knitted fabrics.

### Technical Solution

To achieve the above object, there is provided a suede-like artificial leather according to the present invention, comprising a composite sheet having polyurethane filled therein, the composite sheet comprising: a non-woven fabric of ultrafine short fibers entangled with each other and having a thickness less than 0.3 denier; and a woven or knitted fabric placed in the non-woven fabric, entangled with the ultrafine short fibers of the non-woven fabric, and having an constant load elongation of 10 to 30% at a load of 8 kgf, wherein the tensile strength in longitudinal and lateral directions is 35 to 60 kgf/50 mm and the constant load elongation in longitudinal and lateral directions is 8 to 25%.

Hereinafter, the present invention will now be described in detail.

Firstly, the suede-like artificial leather of the present invention has a tensile strength in longitudinal and lateral directions of 35 to 60 kgf/50 mm and an constant load elongation in longitudinal and lateral directions of 8 to 25%.

In a case where the artificial leather is used for materials for furniture, vehicles, etc., there is required mounting workability for adequately extending the artificial leather so as to make sewing and mounting works easier, as well as form stability for preventing too much extension. In terms of form stability, if the constant load elongation is greater than 25%, the artificial leather continues to be extended during use, thereby damaging the permanent value of the product. In terms of mounting workability, if the tensile strength is less than 35 kgf/50 mm or the constant load elongation is less than 8%, there is a possibility of damage to the product during mounting, and stress and strain may be exerted on the worker's body. In addition, if the tensile strength is greater than 60 kgf/50 mm, the constant load elongation becomes too low, thereby causing the above-mentioned problems.

A typical artificial leather consists of ultrafine short fibers of less than 0.3 denier and a polyurethane elastomer. However, in the present invention, as means for achieving strength and elongation properties, a woven or knitted fabric having strength and elongation properties is added as a reinforcing material to the typical artificial leather.

The woven or knitted fabric is an important component for allowing the artificial leather product of the present invention to achieve strength and elongation properties.

More importantly, the strength and elongation properties of the product differ greatly depending on the warp and weft density of the non-woven or knitted fabric to be inserted as a reinforcing material and the constant load elongation thereof. Particularly, it is very important to entangle the ultrafine short fibers in the non-woven fabric integrally with the woven or knitted fabric in order to achieve satisfactory appearance and physical properties. In case of production by a needle punching method, the warp and weft densities of the woven or knitted fabric are preferably 20 to 100 yarns/inch. If the density is less than 20 yarns/inch, it is too weak to adequately function as the reinforcing material, thereby degrading the tensile strength of the product. If the density is greater than 100 yarns/inch, there is a greater possibility of damage to the reinforcing material while a needle is passing through meshes of the woven or knitted fabric. In this case, the constant load elongation of the reinforcing material is reduced, thereby also deteriorating the constant load elongation of the product.

Additionally, the constant load elongation, measured under a load of 8 kgf, of the woven or knitted fabric applied to the present invention is 10 to 30%. The constant load elongation of the woven or knitted fabric is the factor that has the most influence on the constant load elongation of the product. As for a typical artificial leather comprising a non-woven fabric only, consisting of ultrafine short fibers and polyurethane filling material and having no reinforcing material therein, its constant load elongation is too large, so the elongation is not suitable for applications as materials for vehicles or furniture, etc. Thus, as one of the methods for achieving an constant load elongation a woven or knitted fabric is inserted and interposed, which makes the constant load elongation of the woven or knitted fabric very important. The constant load elongation of the woven or knitted fabric tends to become smaller when the woven or knitted fabric is coupled to a non-woven fabric. Therefore, in order to have an constant load elongation of greater than 8% and less than 25%, it is most preferable that the woven or knitted fabric has the aforementioned constant load elongation.

Additionally, the woven or knitted fabric used in the present invention may consist of one or two or more of yarns selected from the group consisting of a polyethylene terephthalate yarn, a polytrimethylene terephthalate yarn, a polyamide yarn, a polyurethane yarn, a polyethylene yarn and a polypropylene yarn. Moreover, the yarn comprising the woven or knitted fabric is a filament yarn or staple yarn.

The reinforcing woven or knitted fabric may be entangled to a short fiber web layer of a non-woven fabric by a needle punching method, or crosslinked thereto by a high pressure water jet.

The production of a suede-like artificial leather of the present invention having excellent strength and elongation properties is accomplished by the following series of process steps.

Concretely, a woven or knitted fabric having an constant load elongation of 10 to 30% measured under a load of 8 kgf is prepared, and then an ultrafine short fiber web having a thickness of less than 0.3 deniers after dissolution or separation is prepared, thereby bonding the woven or knitted fabric layer and the ultrafine web layer by a needle punching method. A needle whose number of needle barbs is one or less is used in order to prevent damage to the woven or knitted fabric layer, and the probability of contact with the woven or knitted fabric is minimized by adjusting the angle of the barbs. A punching density required for bonding is preferably 1500 to 3000 times per unit area of 1 cm². The density of the composite sheet with the woven or knitted fabric bonded therein should fall within the range of 0.200 to 0.250 g/cm².

The ultrafine short fibers of less than 0.3 deniers used in the present invention may consist of one or two or more of a polyamide polymer, a polyester polymer, polyolefin polymer, and a polyurethane polymer.

A 3 to 15% concentration water soluble polymer solution of polyvinyl alcohol or carboxymethylcellulose is padded and dried on the composite sheet of the non-woven fabric and the woven or knitted fabric so as to have the amount of 5 to 20% by weight with respect to the weight of the fibers. This process is effective for preventing the touch of the final product from being hard resulting from the polyurethane resin being excessively bonded with the fibers converted into a bundle of fine fibers in the later process of impregnating polyurethane resin.

Next, a polyurethane wet impregnating treatment is carried out on the composite sheet. The polyurethane elastomer used in this step is easily dissolved in a straight-chained polymer material consisting of macroglycol, diisocyanate and a low molecular weight diol or diamine, or in some crosslinking polymer materials such as dimethylformamide (hereinafter, refer to as “DMF”).

The macroglycol used in the present invention may include polyether glycol, polyester glycol, polyether polyester copolymer glycol, polycarbonate glycol and the like.

The low molecular weight diols in the present invention may include 4,4′-butandiol, ethylene glycol and the like. It also may use a chain extender of diamine base such as methylene-bis-(4,4′-phenylamine). An impregnating solution is made by adding a detergent, pigments, functional particles and the like to such a DMF solution of polyurethane elastomer and diluting the resulting solution.

The composite sheet is dipped in the impregnating solution, then the polyurethane is coagulated in an aqueous solution, washed in hot water at 50 to 80° C. so as to completely removing temporary filled water soluble polymer, and then dried. The content of the polyurethane after drying is preferably 20 to 50% by weight with respect to the weight of the composite sheet

Continuously, the fibers are converted into a bundle of fine fibers by removing the dissolution component (sea component) with a solvent or aqueous solution of sodium hydroxide which is capable of dissolving or separating the dissolution component.

In case that the dissolution component (sea component) is a copolymerized polyester, the sea component is decomposed by a continuous or discontinuous arrangement method with a 5 to 15% aqueous solution of sodium hydroxide. In case that the dissolution component is polyethylene or polystyrene, the sea component is removed by treating with toluene, perchloroethylene or trichloroethylene.

For example, the copolymerized polyester of the sea component is completely decomposed and removed by treating with a 10% aqueous solution of sodium hydroxide at 100° C. for 5 to 10 minutes. At this time, although the thickness of the composite sheet constructed of the non-woven fabric and the woven or knitted fabric is decreased to some degree because their dissolution component (sea component) is removed, the form of the composite sheet is kept well by the structure of the woven or knitted fabric, the degree of longitudinal elongation caused by a mechanical tensile force is not large and the apparent density of the surface of the composite sheet is improved.

Next, the surface of the thusly obtained composite sheet of the leather form is buffed by a buffing machine equipped with a sand paper of a proper roughness to thus form raised fibers on the surface and then fluffs are shagged. The roughness of the sand paper is selected according to its use. Typically, it is preferable to use the sand paper of 150 to 400 meshes.

The composite sheet of the leather form with the fluffs formed therein is dyed according to its use. In case that the used fiber comprises nylon-6, it is typically dyed with a metal complex dye or milling type acid dye. In case of polyester, it is dyed with a disperse dye in a high pressure rapid dyeing machine.

Finally, a softening and functional agent treatment is carried out on the dyed product, to thus make a composite suede-like artificial leather of high grade.

The artificial leather produced by the present invention makes sewing and mounting workability on a flexed region easier, as well as having form stability that provides durability against external force because the strength and elongation properties are very excellent, that is, the tensile strength is 35 to 60 kgf and the constant load elongation measured under a load of 8 kgf is 8 to 25%. The artificial leather of the present invention is suitable as high durability material for furniture, vehicles, etc that require shape stability.

In the present invention, various physical properties of the composite sheet for artificial leather are determined as follows.

Thickness and Fineness (Denier) of Ultrafine Fiber

A sample of a cross-section of the composite sheet for artificial leather is taken and a preparation process such as gold coating is applied thereto. The cross sectional photograph of the sample is taken at a constant magnification by a scanning electron microscope (SEM) analyzer. The diameter of one strand of the ultrafine fibers shown on the photograph is evaluated and converted into an actual value, and then the fineness is obtained through the following formula.

Fineness (denier)=9 πD²ρ/4000

In this formula, π is the ratio of the circumference of a circle to the diameter, D is the diameter of the cross section of the ultrafine fiber, and ρ is the density (g/cm³) of the ultrafine fiber. The applied density of nylon is 1.14 and the applied density of polyethylene terephthalate is 1.38.

Constant Load Elongation (%)

Three test pieces each having a width of 50 mm and a length of 250 mm are cut out from a composite sheet of a suede-like artificial leather and from a woven or knitted fabric in the longitudinal and transverse directions and a display line of 100 mm is marked along their center areas. These test pieces are mounted on a fatigue tester (*) at a clamp distance of 150 mm and a 78.4N (8 kg) load (including the load of the lower clamp) is carefully suspended on the test pieces for 10 minutes. With the load being suspended for 10 minutes, the length between the display lines (l₀) is obtained and the constant load elongation is calculated by the following formula;

Constant load elongation (%)=l₀−100

In this formula, to designates the length between the display lines (mm) after suspending the load of 8 kg for ten minutes. * As the fatigue tester, ‘Marlens fatigue tester’ is used.

Tensile Strength (Kgf/50 mm)

Five test pieces, each having a 50 mm width and a 250 mm length, are taken out of a sample, respectively, in the longitudinal and transverse directions.

Upper portions of the test pieces are gripped on a Densiron type or its equivalent tensile strength tester, an appropriate initial load is applied thereto so that the test pieces are upright and consistent with a horizontal line, thereby providing a clamp distance of 150 mm.

The initial load refers to a load required to flatten unnatural wrinkles or bends. Especially, the initial load for an unspecified fabric is set to 1.96 N (200 gf).

The load (kgf/50 mm) required for tearing for the five test pieces are measured at a pulling speed of 200200 mm/min and averaged.

### Advantageous Effect

The present invention makes sewing and mounting workability on a flexed region easier, as well as having form stability that provides durability against external force because the strength and elongation properties are very excellent.

### BEST MODES FOR CARRYING OUT THE INVENTION

Hereinafter, the present invention will be described in detail with reference to examples, but not limited thereto.

### Example 1

A sea-island type composite continuous fiber having a total thickness of 75 deniers convertible into a bundle of fine fibers was prepared from 70% by weight of polyethylene terephthalate as a fiber-forming component and 30% by weight of copolymer polyester as an extraction component through spinning and drawing processes.

At this time, the monofilament of the continuous fiber has a denier of 3.1 and has 16 ultrafine fibers (fiber-forming component) therein. The continuous fiber was crimped and set at 170° C. in order to give it a suitable constant load elongation.

The thusly obtained composite fiber was used as warp and weft in the production of a woven fabric by twisting it at 650 twists per meter in a twisting machine. The warp and weft were produced into a woven fabric which had a warp density of a 70 yarns/inch and a weft density of 70 yarns/inch. The constant load elongation in the length (longitudinal) direction of the woven fabric was 20%, and the constant load elongation in the width (lateral) direction thereof was 22%.

Meanwhile, a short fiber having a length of 51 mm, a monofilament fineness of 2.5 deniers and 36 ultrafine fibers (fiber-forming component) in the monofilament was prepared from 70% by weight of polyethylene terephthalate as a fiber-forming component and 30% by weight of copolymer polyester as an extraction component through spinning and crimp cutting processes. The above-mentioned short fibers formed a web by a carding, cross-lapping process, and this web was combined to the woven fabric by needle-punching during the preparation of a non-woven fabric, thereby forming a composite sheet. Then, the composite sheet of the non-woven fabric and the woven fabric was padded and dried in a 10% aqueous solution of polyvinyl alcohol so as to have the amount of 10% by weight with respect to the weight of the fibers. Afterwards the composite sheet was dipped in a 15% impregnating solution prepared by diluting a polyurethane elastomer of the polyether-polyester copolymer glycol type in dimethylformamide (DMF). Then, the polyurethane was coagulated in the aqueous solution, washed in a 70° C. hydrothermal solution for completely removing polyvinyl alcohol polymer, and dried. The content of polyurethane after the drying step was found to be 35% by weight. The composite sheet of the leather form constructed of the above-mentioned fibers and polyurethane was converted into a bundle of fine fibers by continuously treating it in a 10% aqueous solution of sodium hydroxide at 100° C. for completely removing the sea component, i.e., copolymer polyester, so that only the island component, i.e., the component of polyester fine fibers, was left. Then, a part of the ultrafine fibers was cut out and raised by carrying out buffing treatment using a #240 grit sand paper in order to obtain fluffs, thereby producing a composite sheet of a leather form with excellent strength and elongation properties. Next, the obtained sheet was dyed with a disperse dye having an excellent fastness in a high pressure rapid dyeing machine. Then the sheet was reduced, cleared, and dried. Continuously, water repellent and antistatic agent treatment and fluff tip softening treatment were carried out to thus prepare a suede-like composite sheet for artificial leather. The physical properties of the thus obtained composite sheet for artificial leather were evaluated and the result was shown in Table 2.

### Examples 2 to 3 and Comparative Examples 1 and 2

Except that the type and fineness of the warp and weft used in the production of a woven fabric are changed as in Table 1, a composite sheet for artificial leather was prepared in the same manner as that in Example 1. The physical properties were evaluated and shown in Table 2.

TABLE 1
Preparation Conditions

| | | | | Comparative | Comparative |
|---|---|---|---|---|---|
| Classification | Example 1 | Example 2 | Example 3 | Example 1 | Example 2 |
| Component of yarn | Polytrimethylene | Polyamide | Polyethylene | Polyethylene | Polyethylene |
| of fabric | terephthalate | | terephthalate | terephthalate | terephthalate |
| Fineness (denier) of | 0.14 | 0.24 | 0.06 | 0.14 | 0.14 |
| fiber of yarn | | | | | |
| Warp and weft | 70 × 70 | 40 × 40 | 70 × 70 | 25 × 25 | 100 × 100 |
| density of fabric | | | | | |
| Constant load | 20 | 25 | 15 | 35 | 5 |
| elongation of fabric | | | | | |
| in longitudinal | | | | | |
| direction (%) | | | | | |
| Constant load | 22 | 29 | 18 | 40 | 6 |
| elongation of fabric | | | | | |
| in longitudinal | | | | | |
| direction (%) | | | | | |

TABLE 2
Result of Evaluation of Physical Properties of Composite Sheet
of Suede-like Artificial Leather

| | | | | Comparative | Comparative |
|---|---|---|---|---|---|
| Classification | Example 1 | Example 2 | Example 3 | Example 1 | Example 2 |
| Tensile strength | 55 × 56 | 46 × 43 | 48 × 45 | 30 × 29 | 60 × 56 |
| (longitudinal | | | | | |
| direction × lateral | | | | | |
| direction) (kgf/50 mm) | | | | | |
| Constant load | 11 × 14 | 19 × 24 | 15 × 17 | 28 × 30 | 4 ×5 |
| elongation | | | | | |
| (longitudinal | | | | | |
| direction × lateral | | | | | |
| direction) (%) | | | | | |

* The longitudinal direction is a warp direction of a woven or knitted fabric constituting the composite sheet for a suede-like artificial leather, and the lateral direction is a weft direction of the woven or knitted fabric.

### INDUSTRIAL APPLICABILITY

The present invention makes sewing and mounting workability on a flexed region easier, as well as having form stability that provides durability against external force because the strength and elongation properties are very excellent.

Due to this, the present invention is useful as materials for furniture and vehicles requiring durability.

1. A suede-like artificial leather, comprising a composite sheet having polyurethane filled therein, the composite sheet comprising: a non-woven fabric of ultrafine short fibers entangled with each other and having a thickness less than 0.3 denier; and a woven or knitted fabric placed in the non-woven fabric, entangled with the ultrafine short fibers of the non-woven fabric, and having an constant load elongation of 10 to 30% at a load of 8 kgf, wherein the tensile strength in longitudinal and lateral directions is 35 to 60 kgf/50 mm and the constant load elongation in longitudinal and lateral directions is 8 to 25%

2. The suede-like artificial leather of claim 1, wherein the warp and weft densities of the woven or knitted fabric are 20 to 100 yarns/inch

3. The suede-like artificial leather of claim 1, wherein the woven or knitted fabric consists of a filament yarn or staple yarn.

4. The suede-like artificial leather of claim 1, wherein the woven or knitted fabric consists of one or two or more of yarns selected from the group consisting of a polyethylene terephthalate yarn, a polytrimethylene terephthalate yarn, a polyamide yarn a polyurethane yarn, a polyethylene yarn and a polypropylene yarn.

5. The suede-like artificial leather of claim 1, wherein the density of the composite sheet is 0.200 to 0.250 g/cm².
